(19) United States
(12) Patent Application Publication
(10) Pub. No.: US 2022/0303911 A1
(43) Pub. Date: Sep. 22, 2022

(54) METHODS FOR ADAPTING PUR POWER CONTROL MECHANISM

(71) Applicant: TELEFONAKTIEBOLAGET LM ERICSSON (PUBL), STOCKHOLM (SE)

(72) Inventors: Gerardo Agni Medina Acosta, MÄRSTA (SE); Sandeep Narayanan Kadan Veedu, TÄBY (SE)

(21) Appl. No.: 17/639,168

(22) PCT Filed: Aug. 26, 2020
(86) PCT No.: PCT/IB2020/057976

§ 371 Date: Feb. 28, 2022

Related U.S. Application Data
(60) Provisional application No. 62/891,930, filed on Aug. 26, 2019.

(51) Int. Cl. H04W 52/14; H04W 52/08; H04W 52/10

(52) U.S. Cl. CPC H04W 52/146; H04W 52/08; H04W 52/10

(57) ABSTRACT

According to certain embodiments, a method performed by a wireless device comprises sending a Preconfigured Uplink Resources (PUR) transmission to a network node and receiving a response to the PUR transmission from the network node. The method further comprises selecting a type of power control for a subsequent PUR transmission. Selecting the type of power control is based at least in part on the response to the PUR transmission. The method further comprises sending the subsequent PUR transmission according to the selected type of power control.

### RELATED APPLICATIONS

This application claims priority to U.S. Patent Application No. 62/891,930, filed Aug. 26, 2019, the disclosure of which is hereby incorporated by reference in its entirety.

### TECHNICAL FIELD

Certain embodiments of the present disclosure relate, in general, to wireless communications and, more particularly, to adapting power control for a preconfigured uplink resources (PUR) transmission.

### BACKGROUND

The third generation partnership project (3GPP) refers to a partnership among organizations that develop standards for wireless communications. Release 16 (Rel-16) of the 3GPP standard includes approval for Work Item RP-181878 (“Additional MTC enhancements for LTE,” Ericsson, RAN #81, Gold Coast, Australia, Sep. 10-13, 2018) and Work Item RP-181674 (“WID revision: Additional enhancements for NB-IoT,” Huawei, RAN #81, Australia, Sep. 10-13, 2018). Work Items RP-181878 and RP-181674 have the following objective in common:

Improved UL transmission efficiency and/or UE power consumption:

```
Specify support for transmission in preconfigured resources in idle
and/or connected mode based on SC-FDMA waveform for UEs
with a valid timing advance [RAN1, RAN2, RAN4]
  Both shared resources and dedicated resources can be discussed
  Note: This is limited to orthogonal (multi) access schemes
```

The 3GPP working group responsible for radio layer 1 (RAN1) held a meeting (RAN1 #94bis) in Chengdu, People's Republic of China, on Oct. 8-12, 2018. The 3GPP RAN1 #94bis meeting resulted in three definitions that will apply for the transmissions on preconfigured uplink resources (PUR):

Agreement

```
Dedicated preconfigured UL resource is defined as a PUSCH resource
used by a single UE
  PUSCH resource is time-frequency resource
  Dedicated PUR is contention-free
Contention-free shared preconfigured UL resource (CFS PUR) is defined
as a PUSCH resource simultaneously used by more than one UE
  PUSCH resource is at least time-frequency resource
  CFS PUR is contention-free
Contention-based shared preconfigured UL resource (CBS PUR) is
defined as a PUSCH resource simultaneously used by more than one UE
  PUSCH resource is at least time-frequency resource
  CBS PUR is contention-based (CBS PUR may require contention
  resolution)
```

In RAN1 #94bis, it was agreed that “[i]n idle mode, dedicated PUR is supported.” The support of shared PUR schemes (e.g., the “CFS PUR” and “CBS PUR” categories) was left for further study.

The support of transmissions on pre-configured uplink (UL) resources in IDLE mode is tied to the condition of being in possession of a valid timing advance (TA) and guaranteeing that it is still valid by the time the transmission on pre-configured UL resources is to be performed.

The 3GPP RAN1 working group held a meeting (RAN1 #96) in Athens, Greece, Feb. 25-Mar. 1, 2019. During the 3GPP RAN1 #96 meeting, the RAN1 working group reached the following agreements with regard to configuring and updating the PUR power control parameters:

Agreement:

```
For dedicated PUR, in idle mode, the PUR resource configuration
includes at least the following:
  Time domain resources including periodicity(s)
    Note: also includes number of repetitions, number of resource units
    (RUs), starting position
  Frequency domain resources
  Transport Block Size(s) (TBS(s))/Modulation and Coding Scheme(s)
  (MCS(s))
  Power control parameters
  Legacy demodulation reference signal (DMRS) pattern
```

Agreement:

```
In idle mode, at least the following PUR configurations and PUR
parameters may be updated after a PUR transmission:
  Timing advance adjustment
  User equipment (UE) transmission (TX) power adjustment
  For-further-study: Repetition adjustment for physical uplink shared
  channel (PUSCH)
  For-further-study: Whether the above update is done in layer 1 (L1)
  and/or higher layer
```

In addition, the 3GPP RAN1 working group held a meeting (RAN1 #96bis) in Xi'an, China, 8-12 Apr. 2019. During the 3GPP RAN1 #96bis meeting, the RAN1 working group reached the following agreement:

Agreement:

The power control parameters within the PUR configuration, shall at
least include:
Target UL power level (P_0) for the PUR transmission

### Power Control for MTC

The 3GPP has developed Technical Specification (TS) 36.213, “Evolved Universal Terrestrial Radio Access (E-UTRA); Physical layer procedures.” According to TS 36.213 version 15.2.0, the setting of the UE Transmit power for a Physical Uplink Shared Channel (PUSCH) transmission is defined as follows.

If the UE transmits PUSCH without a simultaneous Physical Uplink Control Channel (PUCCH) for the serving cell c, then the UE transmit power P_{PUSCH,c}(i) for PUSCH transmission in subframe/slot/subslot i for the serving cell c is given by:

$${P}_{PUSCH , c} ( i ) = min \{ \begin{matrix}{P}_{CMAX , c} ( i ) , \\ 10 {log}_{10} ( {M}_{P U SCH , c} ( i ) ) + {P}_{O \_ PUSCH , c} ( j ) + {α}_{c} ( j ) \cdot {PL}_{c} + {Δ}_{TF , c} ( i ) + {f}_{c} ( i )\end{matrix} \} [ dBm ]$$

where,
P_{CMAX,c}(i) is the configured UE transmit power defined in subframe/slot/subslot i for serving cell c.
P_{O_PUSCH,c}(j) is a parameter composed of the sum of a component P_{O_NOMINAL_PUSCH,c}(j) provided from higher layers for j=0 and 1 and a component P_{O_UE_PUSCH,c}(j) provided by higher layers for j=0 and 1 for serving cell c. For PUSCH (re)transmissions corresponding to a semi-persistent grant then j=0, for PUSCH (re)transmissions corresponding to a dynamic scheduled grant then j=1 and for PUSCH (re)transmissions corresponding to the random access response grant then j=2.

α_{c}(j)=α_{c,2} ∈ {0, 0.4, 0.5, 0.6, 0.7, 0.8, 0.9, 1}.
PL_{c} is the downlink path loss estimate calculated in the UE for serving cell c in dB.
M_{PUSCH,c}(i) is the PUSCH bandwidth related parameter.
f_{c}(i)=f_{c}(i−1)+δ_{PUSCH,c}(i−K_{PUSCH}) if accumulation is enabled and f_{c}(i)=δ_{PUSCH,c}(i−K_{PUSCH}) if accumulation is not enabled. δ_{PUSCH,c} is a correction value, also referred to as a TPC command.

The TPC command δ_{PUSCH,c} is carried in a Machine Type Communication (MTC) Physical Downlink Control Channel (MPDCCH) with downlink control information (DCI) format 6-0A for serving cell c. The inclusion of the TPC command makes this a closed-loop power control mechanism. Otherwise, it is typically (and in this disclosure) referred to as an open-loop power control mechanism.

Moreover, for a Bandwidth reduced Low complexity (BL)/Coverage Enhancement (CE) UE configured with CEModeA, if the PUSCH is transmitted in more than one subframe i₀, i₁, . . . , i_{N-1}, where i₀<i₁< . . . <i_{N-1}, the PUSCH transmit power in subframe iₖ, k=0, 1, . . . , N−1, is determined by:

P_{PUSCH,c}(iₖ)=P_{PUSCH,c}(i₀)

For a BL/CE UE configured with CEModeB, the PUSCH transmit power in subframe iₖ is determined by:

P_{PUSCH,c}(iₖ)=P_{CMAX,c}(i₀)

### SUMMARY

There currently exist certain challenge(s). For dedicated PUR in idle mode, as mentioned above, it has been agreed in the 3GPP RAN1#96bis meeting that the UEs receive the initial PUR configuration via UE-specific radio resource control (RRC) signaling. It has also been agreed that the power control parameters within the PUR configuration shall at least include target UL power level (P_0) for the PUR transmission (in this disclosure and in the 3GPP specification P_0 is denoted as P_{O_PUSCH,c}(j)).

There needs to be additional considerations while applying the legacy physical uplink shared channel (PUSCH) power control expressions for PUSCH transmissions corresponding to PUR. After the PUR transmission, depending on the success or failure of the reception at the eNodeB (e.g., base station), the UE may receive an acknowledgement (ACK) (via layer 1, L1, or layer 2, L2, or higher-layer signaling) or an UL (dynamic) retransmission grant (L1 signaling). Thus, on one hand, the UE may receive a retransmission grant within few subframes, and the UE will retransmit shortly after it, using the received UL grant. On the other hand, if it is an ACK that is received after the PUR transmission, the next PUR transmission may happen far away in time (depending on the PUR's periodicity, UE's speed, etc.), and the provided power control parameters most likely would be outdated. This may happen even if the UE's are stationary since there may be changes in the channel conditions due to the movement of other objects in the environment.

The network node may also have the possibility of updating PUR configurations and/or PUR parameters, including power control parameters using ACK or an UL grant. However, due to the limited size of the DCI Formats 6-0A/B and mainly due to the long periodicities of the PUR transmissions, it may not always be useful or may not even be possible to always have power control parameters included as part of the ACK/UL grant.

Certain aspects of the present disclosure and their embodiments may provide solutions to these or other challenges. Certain embodiments of the present disclosure propose methods for adapting the PUR power control mechanism. Certain embodiments of the present disclosure propose methods to adaptively switch the UE between closed-loop and open-loop power control mechanism for the subsequent PUR transmission. In more detail, the network node determines the type of response (ACK/UL grant) to the PUR transmission and the periodicity of PUR transmissions and, based on this information, adapts the power control mechanism to be used by the UE for the subsequent transmission.

There are two variants for performing the closed/open-loop power control switching:
The switching between closed-loop to open-loop and vice versa depends on whether an “UL-Grant” or an “ACK” was received in response to a PUR Transmission: That is, upon receiving an “UL-Grant” a closed-loop power control is used by the UE in the subsequent PUR transmission (which is indeed a retransmission), whereas if what was received was either a L1-ACK or a L2/L3-ACK then an open-loop power control is used by the UE in the subsequent PUR transmission (which a regular PUR transmission).
The switching between closed-loop to open-loop and vice versa depends on PUR transmission periodicity and on whether an “UL-Grant” or an “ACK” was received in response to a PUR Transmission: That is, upon receiving an “UL-Grant” a closed-loop power control is used by the UE in the subsequent PUR transmission (which is indeed a retransmission), whereas if what was received was either a L1-ACK or a L2/L3-ACK then the length of the PUR periodicity determines whether to use an open-loop power control (long PUR periodicities) or closed-loop power control (short PUR periodicities) in the subsequent PUR transmission (which is a regular PUR transmission).

Thus, certain embodiments of the present disclosure propose methods to adaptively switch the UE between the type of power control mechanism used for the subsequent PUR transmission. In more detail, the network node determines the type of response (ACK/UL grant) to the PUR transmission and the periodicity of PUR transmissions, and based on them adapts the power control mechanism to be used by the UE for the subsequent transmission.

There are, proposed herein, various embodiments which address one or more of the issues disclosed herein.

According to certain embodiments, a wireless device comprises power supply circuitry and processing circuitry. The power supply circuitry is configured to send a PUR transmission to a network node, receive a response to the PUR transmission from the network node, and select a type of power control for a subsequent PUR transmission based at least in part on the response to the PUR transmission. The processing circuitry is further configured to send the subsequent PUR transmission according to the selected type of power control.

According to certain embodiments, a method performed by a wireless device comprises sending a PUR transmission to a network node, receiving a response to the PUR transmission from the network node, and selecting a type of power control for a subsequent PUR transmission based at least in part on the response to the PUR transmission. The method further comprises sending the subsequent PUR transmission according to the selected type of power control.

According to certain embodiments, a computer program comprises instructions which when executed on a computer perform sending a PUR transmission to a network node, receiving a response to the PUR transmission from the network node, and selecting a type of power control for a subsequent PUR transmission based at least in part on the response to the PUR transmission. The instructions, when executed on a computer, further perform sending the subsequent PUR transmission according to the selected type of power control.

The above-described wireless device, method in a wireless device, and computer program may include one or more additional features, such as any one or more of the following features:

In certain embodiments, closed-loop power control is selected as the type of power control based at least in part on receiving an uplink grant message as the response to the PUR transmission. In certain embodiments, the subsequent PUR transmission comprises a retransmission of the PUR transmission, and the closed-loop power control comprises adjusting a transmission power of the wireless device based at least in part on a TPC command received from the network node.

In certain embodiments, open-loop power control is selected as the type of power control based at least in part on receiving an acknowledge message as the response to the PUR transmission. In certain embodiments, the subsequent PUR transmission comprises a transmission that is not a retransmission, and the open-loop power control comprises adjusting a transmission power of the wireless device based at least in part on a calculation where a closed-loop component has been omitted or set to zero.

Certain embodiments switch the type of power control such that the PUR transmission that is not a retransmission is sent according to open-loop power control and the subsequent PUR transmission in case it corresponds to a retransmission is sent according to closed-loop power control.

Certain embodiments switch the type of power control such that the PUR transmission that corresponds to a retransmission is sent according to closed-loop power control and the subsequent PUR transmission that is not a retransmission is sent according to open-loop power control.

In certain embodiments, the wireless device is in CE Mode A. Certain embodiments further comprise determining that the wireless device has entered CE Mode B and sending one or more PUR retransmissions according to a maximum transmission power when in CE Mode B.

In certain embodiments, the type of power control is further based on a PUR transmission periodicity. As an example, when the response to the PUR transmission comprises an acknowledge message, selecting the type of power control comprises selecting open-loop power control when a length of the PUR transmission periodicity exceeds a pre-determined length. As another example, when the response to the PUR transmission comprises an acknowledge message, selecting the type of power control comprises selecting closed-loop power control when the length of the PUR transmission periodicity is less than the pre-determined length.

According to certain embodiments, a network node comprises power supply circuitry and processing circuitry. The power supply circuitry is configured to supply power to the network node. The processing circuitry is configured to receive a PUR transmission from a wireless device, send a response to the PUR transmission to the wireless device, and determine a type of power control for receiving a subsequent PUR transmission. The type of power control is determined based at least in part on the response to the PUR transmission. The processing circuitry is further configured to receive the subsequent PUR transmission according to the determined type of power control.

According to certain embodiments, a method in a network node comprises receiving a PUR transmission from a wireless device, sending a response to the PUR transmission to the wireless device, and determining a type of power control for receiving a subsequent PUR transmission. The type of power control is determined based at least in part on the response to the PUR transmission. The method further comprises receiving the subsequent PUR transmission according to the determined type of power control.

According to certain embodiments, a computer program comprises instructions which when executed on a computer perform receiving a PUR transmission from a wireless device, sending a response to the PUR transmission to the wireless device, and determining a type of power control for receiving a subsequent PUR transmission. The type of power control is determined based at least in part on the response to the PUR transmission. The instructions, when executed on a computer, further perform receiving the subsequent PUR transmission according to the determined type of power control.

The above-described network node, method in a network node, and computer program may include one or more additional features, such as any one or more of the following features:

Certain embodiments determine closed-loop power control as the type of power control based at least in part on sending an uplink grant message as the response to the PUR transmission. In certain embodiments, the subsequent PUR transmission comprises a retransmission of the PUR transmission, and the closed-loop power control comprises sending the wireless device a TPC command.

Certain embodiments determine open-loop power control as the type of power control based at least in part on sending an acknowledge message as the response to the PUR transmission. In certain embodiments, the subsequent PUR transmission comprises a transmission that is not a retransmission, and the open-loop power control comprises sending the wireless device a TPC command set to zero or abstaining from sending the TPC command to the wireless device.

Certain embodiments switch the type of power control such that the PUR transmission that is not a retransmission is received according to open-loop power control and the subsequent PUR transmission in case it corresponds to a retransmission is received according to closed-loop power control.

Certain embodiments switch the type of power control such that the PUR transmission that corresponds to a retransmission is received according to closed-loop power control and the subsequent PUR transmission that is not a retransmission is received according to open-loop power control.

In certain embodiments, the wireless device is in CE Mode A. Certain embodiments determine that the wireless device has entered CE Mode B and receive one or more PUR retransmissions according to a maximum transmission power of the wireless device when the wireless device is in CE Mode B.

Certain embodiments determine the type of power control further based on a PUR transmission periodicity. As an example, when the response to the PUR transmission comprises an acknowledge message, certain embodiments determine open-loop power control as the type of power control when a length of the PUR transmission periodicity exceeds a pre-determined length. As another example, when the response to the PUR transmission comprises an acknowledge message, certain embodiments determine closed-loop power control as the type of power control when the length of the PUR transmission periodicity is less than the pre determined length.

Certain embodiments may provide one or more of the following technical advantage(s). For example, the proposed adaptive switching of closed/open-loop power control mechanism may provide the following advantages:
The UEs use only appropriate power levels while transmitting over PUR. Using appropriate power levels increases the probability that the eNodeB can successfully receive the transmissions over PUR resources. Additionally, using appropriate power levels reduces interference in the network.
Increased energy efficiency at the UE and efficient use of PUR resources.
For the two variants for performing the closed/open-loop power control switching:
   When the switching between closed-loop to open-loop and vice versa depends on whether an “UL-Grant” or an “ACK” was received in response to a PUR Transmission, one of the advantages is that the L1 ACK does not have to include a “TPC command field” (no L1 bits are used for this purpose).
   When the switching between closed-loop to open-loop and vice versa depends on PUR transmission periodicity and on whether an “UL-Grant” or an “ACK” was received in response to a PUR Transmission, the L1-ACK has to include a “TPC command field” (L1 bits are used for this purpose) but this variant addresses use cases of PUR using both long and short periodicities.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a wireless network, in accordance with some embodiments.

FIG. 2 illustrates a user equipment, in accordance with some embodiments.

FIG. 3 illustrates a virtualization environment, in accordance with some embodiments.

FIG. 4 illustrates a telecommunication network connected via an intermediate network to a host computer, in accordance with some embodiments.

FIG. 5 illustrates a host computer communicating via a base station with a user equipment over a partially wireless connection, in accordance with some embodiments.

FIG. 6 illustrates methods implemented in a communication system including a host computer, a base station and a user equipment, in accordance with some embodiments.

FIG. 7 illustrates methods implemented in a communication system including a host computer, a base station and a user equipment, in accordance with some embodiments.

FIG. 8 illustrates methods implemented in a communication system including a host computer, a base station and a user equipment, in accordance with some embodiments.

FIG. 9 illustrates methods implemented in a communication system including a host computer, a base station and a user equipment, in accordance with some embodiments.

FIG. 10 illustrates a method implemented in a wireless device, in accordance with some embodiments.

FIG. 11 illustrates a virtualization apparatus, in accordance with some embodiments.

FIG. 12A illustrates a method implemented in a wireless device, in accordance with some embodiments.

FIG. 12B illustrates a method implemented in a wireless device, in accordance with some embodiments.

FIG. 13 illustrates a method implemented in a network node, in accordance with some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Depending upon the outcome in 3GPP, after the PUR transmission, based on the success or failure of the transmission, the UE may receive an ACK (via L1 signaling or L2/higher-layer signaling) or an UL (dynamic) retransmission grant (L1 signaling). Using these, the network node may also have the possibility of updating PUR configurations and/or PUR parameters, including power control parameters.

However, it may not always be useful or may not even be possible to have power control parameters included as part of the ACK/UL grant. For instance, upon unsuccessful reception of the PUR transmission at the eNodeB, the UE may receive a retransmission grant within few subframes, and the UE will retransmit shortly after it, using the received UL grant. On the other hand, if an ACK is received after the PUR transmission, the next PUR transmission may occur far away in time, and the provided power control parameters most likely would be outdated. This may happen even if the UE's are stationary since there may be changes in the channel conditions due to the movement of other objects in the environment. Therefore, this disclosure proposes methods, based on the type of received response (ACK/UL grant) after the PUR transmission and, in some cases, based on how far away the subsequent PUR transmission is, to adaptively switch UE's power control mechanism used for the subsequent PUR transmission.

In one embodiment, upon receiving an “UL-Grant” a closed-loop power control is used by the UE in the subsequent PUR transmission (i.e., a retransmission), whereas if what was received was either a L1-ACK or a L2/L3-ACK, then an open-loop power control is used by the UE in the subsequent PUR transmission (which is a regular PUR transmission).

In one other embodiment, upon receiving an “UL-Grant” a closed-loop power control is used by the UE in the subsequent PUR transmission (i.e., a retransmission), whereas if what was received was either a L1-ACK or a L2/L3-ACK, then the length of the PUR periodicity determines whether to use an open-loop power control (long PUR periodicities, e.g., the PUR periodicity is larger than x seconds) or closed-loop power control (short PUR periodicities, e.g., the PUR periodicity is less than x seconds) in the subsequent

PUR transmission (which is a regular PUR transmission).

Let T(0) be the time instance that the UE obtains the PUR configuration via UE specific RRC signaling. Let T(i) be the time instance when the current PUR transmission takes place, and T(i+1) be the time instance when the subsequent PUR transmission takes place. In this disclosure, examples of time units may be in terms of time (e.g., milliseconds, seconds), time resources (e.g., in slots, subframes, frames, system frame number (SFN) cycle, hyper SFN cycle, etc.), or discontinuous reception (DRX) cycles (e.g., as 5 DRX cycles, 10 DRX cycles, etc.).

In one embodiment, due to the successful reception of the of the PUR transmission at the eNodeB, if the UE receives a L1 ACK, a closed-loop power control mechanism is used at the UE only if the following condition is fulfilled:

T(i+1)−T(i)<X

where X is in any time units. In other words, if the time difference of the current PUR transmission and the subsequent PUR transmission is less than X time units, then the UE uses a closed-loop power control mechanism for the subsequent PUR transmission, as described above (see “Power control for MTC” in the introduction section). Otherwise, the UE switches to use an open-loop power control mechanism, which can be realized, for example, by setting the bit combination for the TPC command in the DCI Format 6-0A to indicate 0 dB change (in the accumulated mode) or repurpose this field in the DCI for conveying other PUR parameters.

If instead an L2/L3 ACK has been received, the power control parameter, in particular, the UE specific component of P_{O_PUSCH,c}(j), is updated via the PUR reconfiguration message. The UE updates its power control expression based on this, and the UE uses the updated expression for the subsequent PUR transmission.

On the other hand, if the eNB fails to successfully receive the PUR transmission, the eNB sends the UE a (dynamic) UL grant for the PUR retransmission. Upon receiving the (dynamic) UL grant instead of an ACK, the UE switches to the closed-loop power control mechanism as described above (see “Power control for MTC” in the introduction section) for the PUR retransmission. That is, in this scenario, the network (NW) includes, and the UE follows, the TPC command in the UL Grant conveyed via DCI Format 6-0A.

In another aspect of this embodiment, the UE always uses an open-loop power control mechanism as described above upon reception of a L1 ACK irrespective of the value of X.

In another embodiment, at the time of PUR configuration, the UE can be explicitly configured with a closed/open-loop power control mechanism, which the UE will use for all the PUR (re)transmissions. In another aspect of this embodiment, the configured power control mechanism may be updated via the PUR reconfiguration message in the L2/L3 response.

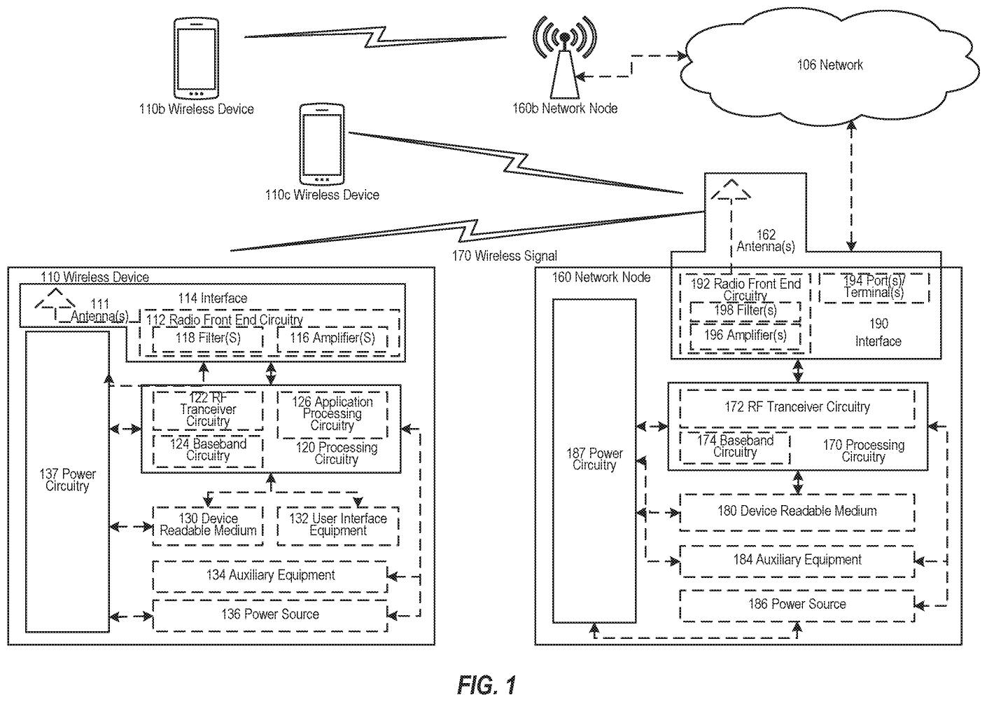

Although the subject matter described herein may be implemented in any appropriate type of system using any suitable components, the embodiments disclosed herein are described in relation to a wireless network, such as the example wireless network illustrated in FIG. 1. For simplicity, the wireless network of FIG. 1 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 1, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 1 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

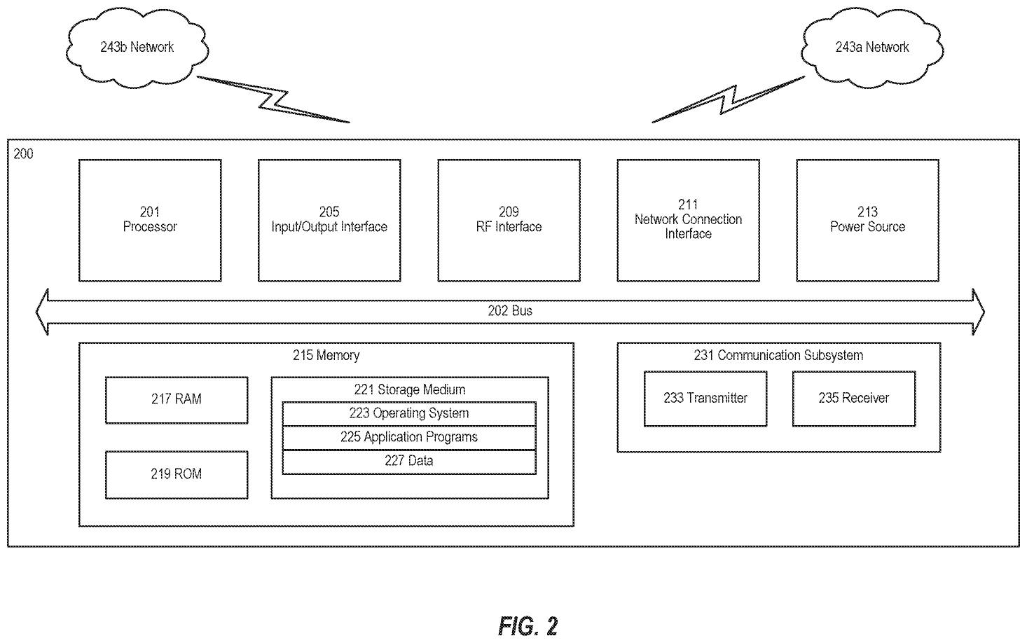

FIG. 2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 2, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 2 is a UE, the components discussed herein are equally applicable to a WD, and vice-versa.

In FIG. 2, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 2, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 2, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 2, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

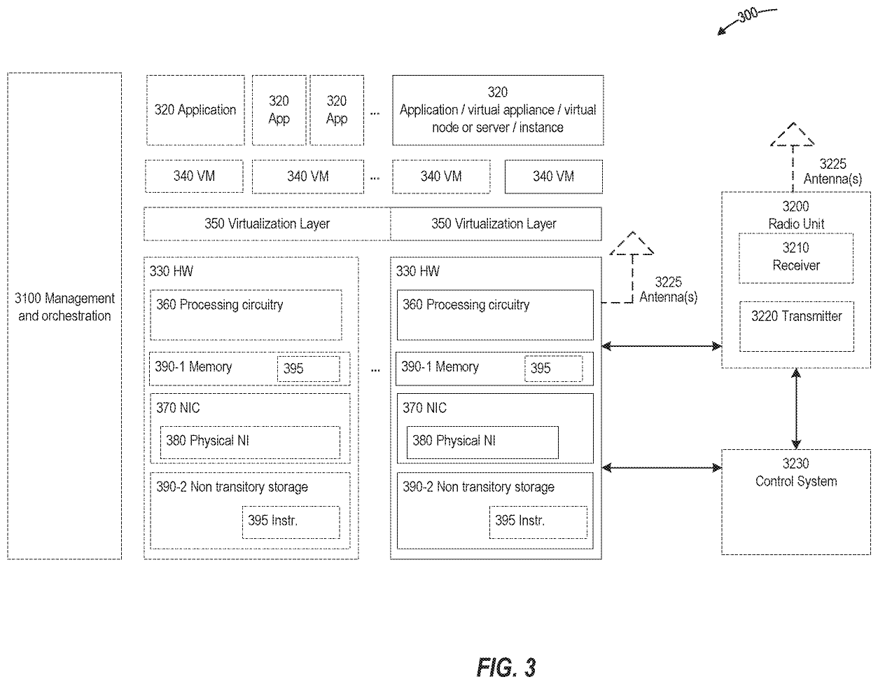

FIG. 3 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

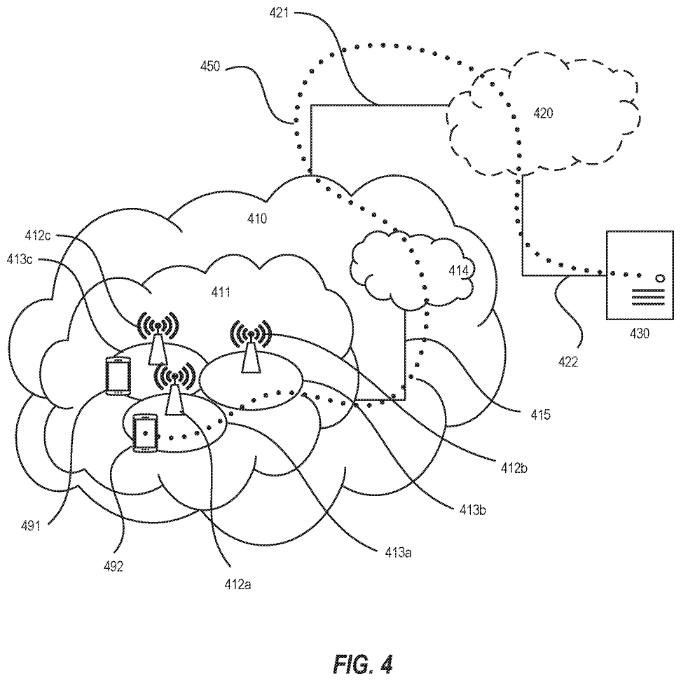

With reference to FIG. 4, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 4 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

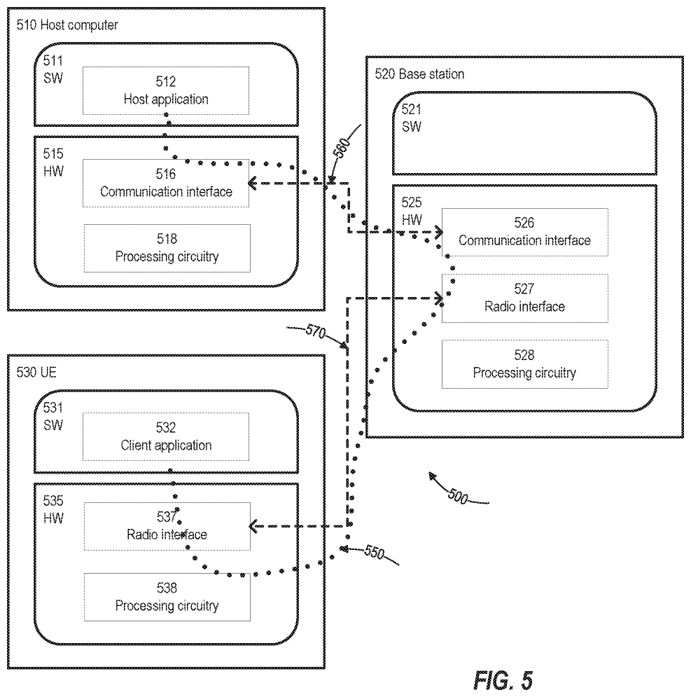

Example implementations, in accordance with an embodiment, of the UE, base station and host computer discussed in the preceding paragraphs will now be described with reference to FIG. 5. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 5, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the power consumption and thereby provide benefits such as extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors, etc.

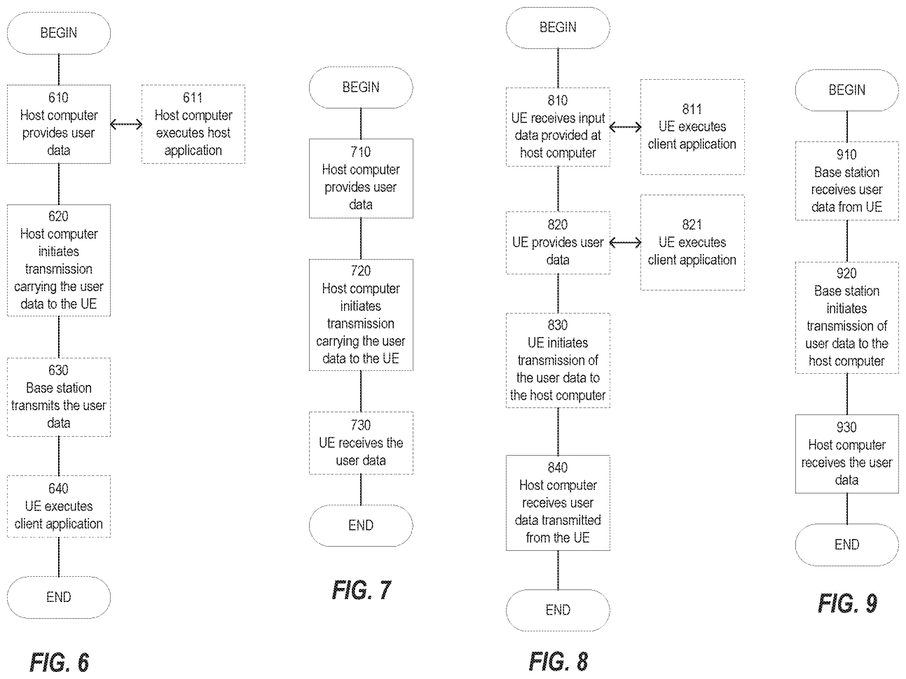

FIG. 6 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 6 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 7 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 7 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

FIG. 8 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 8 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 9 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

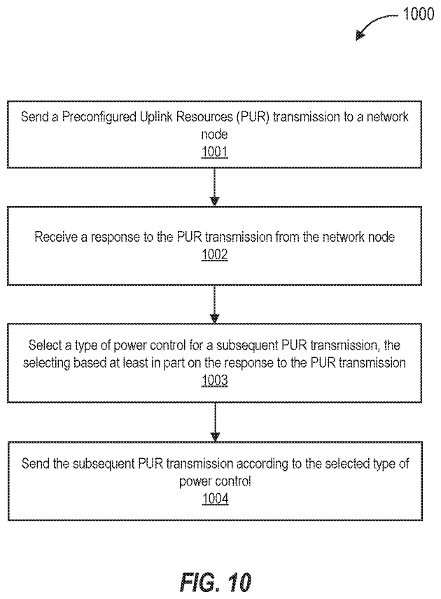

FIG. 10 depicts a method in accordance with particular embodiments. In certain embodiments, the method may be performed by a wireless device (e.g., wireless device 110), such as a UE (e.g., UE 200). For example, processing circuitry 120 (e.g., processing circuitry 201 of UE 200) may be configured to perform the steps of the method.

The method begins at step 1001 with sending a PUR transmission to a network node. For example, prior to step 1001, the wireless device may receive a PUR resource configuration from the network node. The PUR resource configuration may be received in RRC signaling when the wireless device is in connected mode. The PUR resource configuration can include time domain resources (e.g., including PUR transmission periodicity, number of repetitions, number of resource units (RUs), starting position), frequency domain resources, TBS(s), MCS(s), power control parameters, and/or legacy DMRS pattern. When the wireless device later transitions to idle mode, the wireless device may use the PUR resource configuration to send the PUR transmission of step 1001.

The method proceeds to step 1002 with receiving a response to the PUR transmission from the network node. Examples of the response to the PUR transmission include an uplink grant message or an acknowledgement message (such as a layer 1 ACK, layer 2 ACK, or layer 3 ACK). In some embodiments, the response may be received in DCI from the network node. The DCI may follow any suitable format, such as DCI Format 6-0A, DCI Format 6-0B, or DCI Format 6-1A. As an example, DCI Format 6-0A can be used for either L1-ACK or UL-Grant and DCI Format 6-0B can be used for either L2-ACK or L3-ACK.

The method continues to step 1003 with selecting a type of power control for a subsequent PUR transmission. In certain embodiments, the wireless device can select either closed-loop power control or open-loop power control as the type of power control depending at least in part on the response to the PUR transmission. For example, the wireless device may select closed-loop power control based on receiving an uplink grant message in step 1002, or the wireless device may select open-loop power control based on receiving an acknowledge message (e.g., L1-ACK, L2-ACK, or L3-ACK) in step 1002. In certain embodiments, selecting the type of power control is further based on a PUR transmission periodicity. For example, open-loop power control may be selected based on a length of the PUR transmission periodicity exceeding a pre-determined length (e.g., long periodicity) and closed-loop power control may be selected based on a length of the PUR transmission periodicity being less than a pre-determined length (e.g., short periodicity). Other examples of factors for selecting closed-loop power control or open-loop power control are discussed above (e.g., in certain embodiments, the wireless device can be explicitly configured with a closed/open-loop power control mechanism at the time of PUR configuration).

The method ends with step 1004, sending the subsequent PUR transmission according to the selected type of power control. For example, if the UE transmits PUSCH without a simultaneous PUCCH for the serving cell c, then the UE transmission power P_{PUSCH,c}(i) for PUSCH transmission in subframe/slot/subslot i for the serving cell c may be determined based on the following calculation:

$${P}_{PUSCH , c} ( i ) = min \{ \begin{matrix}{P}_{CMAX , c} ( i ) , \\ 10 {log}_{10} ( {M}_{P U SCH , c} ( i ) ) + {P}_{O \_ PUSCH , c} ( j ) + {α}_{c} ( j ) \cdot {PL}_{c} + {Δ}_{TF , c} ( i ) + {f}_{c} ( i )\end{matrix} \} [ dBm ]$$

Both transmissions and retransmissions make use of the above UE transmission power control equation. Thus, in order to switch between closed-loop and open-loop power control, the closed-loop component f_{c}(i) is set to zero for the case of new PUR transmissions (i.e., transmissions other than retransmissions) as to turn the UE transmit power control equation into an open-loop scheme, whereas for the case of retransmissions the closed-loop component f_{c}(i) depends on the TPC command from the network node to provide a closed-loop UE transmit power control scheme, as in the legacy case.

### Closed-Loop Example

As discussed above, certain embodiments select closed-loop power control as the type of power based on receiving an uplink grant message in step 1002. Receiving the uplink grant message indicates that the network node failed to successfully receive the PUR transmission that was sent in step 1001. Thus, the subsequent PUR transmission to be sent in step 1004 comprises a retransmission of the PUR transmission that was sent in step 1001. The amount of time between the PUR transmission and the retransmission is expected to be relatively short, which makes closed-loop power control suitable for the retransmission.

In closed-loop power control, the wireless device may receive downlink control information (DCI) from the network node that includes a correction value (also referred to as a transmission power control (TPC) command), e.g. In some cases of closed-loop power control, accumulation is enabled. In other cases of closed-loop power control, accumulation is not enabled. Enabling the accumulation basically means that the power control adjustment will depend on the sum of the previous adjustment and the adjustment indicated via DCI. Once the retransmission has been successful, the network node will send an ACK (in which case towards the next PUR transmission the wireless device may switch to open-loop power control according to the steps described for the “ACK” case). That is, when the next PUR period or PUR transmission opportunity is reached, the new PUR transmission will make use of the open-loop power control scheme (i.e., f_{c}(i) will be set to zero).

### Open-Loop Example

As discussed above, certain embodiments select open-loop power control as the type of power based on receiving an acknowledgment message in step 1002. An ACK indicates that the network node successfully received the PUR transmission and therefore does not need the wireless device to send a retransmission. The ACK may be received using layer 1, or layer 2/3 signaling. The ACK may optionally include additional information (e.g., an L2/L3-ACK may include certain information to perform a PUR reconfiguration).

The case where the network node successfully receives the transmission (acknowledgement case) differs from case where the network node fails to receive the transmission correctly (retransmission case). As discussed above, in the case of a retransmission, the time between the transmission and the retransmission is relatively short. By contrast, in the case of a successful transmission, the time between the transmission and the new transmission, (i.e., a transmission other than a retransmission) may be relatively long. For example, the timing of the new transmission may be based on a PUR transmission periodicity included with a PUR resource configuration received in RRC signaling prior to step 1001.

Because the previous power control parameters most likely would be outdated when the amount of time between the PUR transmission and the subsequent PUR transmission is long, open-loop power control may be more suitable. In open-loop power control, f_{c}(i) is set to zero. For example, the network node can set the correction value (e.g., TPC command in the DCI Format 6-0A) to indicate 0 dB change. As another example, the network node need not send the correction value. For example, the wireless device can set f_{c}(i) to 0 when in open-loop power control, and the network node may repurpose the TPC command in DCI Format 6-0A for conveying other PUR parameters. Note that f_{c}(i) may be set to 0 for values of i=0, 1, . . . up to the last subframe of the uplink transmission that is using the preconfigured uplink resource.

Configuration Updates

In certain embodiments, if the network node needs to update the PUR resource configuration, the network node can send an indication to the wireless device via L2/L3 signaling using the MPDCCH indicating to monitor the PDSCH which contains the PUR reconfiguration information. As an example, in certain embodiments, the PUR reconfiguration information may be used to update a power control parameter, such as the UE specific component of P_{O_PUSCH,c}(j).

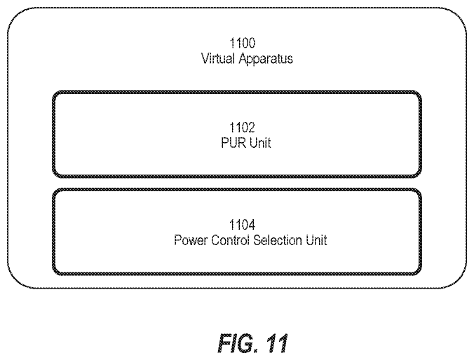

FIG. 11 illustrates a schematic block diagram of an apparatus 1100 in a wireless network (for example, the wireless network shown in FIG. 1). The apparatus may be implemented in a wireless device or network node (e.g., wireless device 110 or network node 160 shown in FIG. 1). Apparatus 1100 is operable to carry out the example method described with reference to FIG. 11 and possibly any other processes or methods disclosed herein. It is also to be understood that the method of FIG. 11 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause PUR unit 1102, power control selection unit 1104, and any other suitable units of apparatus 1100 to perform corresponding functions according one or more embodiments of the present disclosure.

As illustrated in FIG. 11, apparatus 1100 includes PUR unit 1102 and power control selection unit 1104. PUR unit 1102 is configured to send PUR transmissions and receive responses to PUR transmissions. Power control selection unit 1104 is configured to select a type of power control (closed-loop or open-loop) to use when sending the PUR transmissions. In certain embodiments, power control selection unit selects the type of power control based at least in part on the response to the previous PUR transmission (e.g., based on whether the response comprised an uplink grant or an acknowledge message).

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### Example Embodiments

### Group A Embodiments

A method performed by a wireless device, the method comprising:
sending a Preconfigured Uplink Resources (PUR) transmission to a network node;
receiving a response to the PUR transmission from the network node;
selecting a type of power control for a subsequent PUR transmission, the selecting based at least in part on the response to the PUR transmission; and
sending the subsequent PUR transmission according to the selected type of power control.

1. The method of embodiment 1, wherein selecting the type of power control comprises selecting closed-loop power control based on receiving an uplink grant message as the response to the PUR transmission.

2. The method of embodiment 1, wherein selecting the type of power control comprises selecting open-loop power control based on receiving an acknowledge message as the response to the PUR transmission.

3. The method of embodiment 1, wherein selecting the type of power control is further based on a PUR transmission periodicity.

4. The method of embodiment 4, wherein, when the response to the PUR transmission comprises an acknowledge message, selecting the type of power control comprises selecting open-loop power control based on a length of the PUR transmission periodicity exceeding a pre-determined length.

5. The method of embodiment 4, wherein, when the response to the PUR transmission comprises an acknowledge message, selecting the type of power control comprises selecting closed-loop power control based on a length of the PUR transmission periodicity being less than a pre-determined length.

6. The method of any of embodiments 1-6, wherein the method comprises switching the type of power control such that the PUR transmission is sent according to closed-loop power control and the subsequent PUR transmission is sent according to open-loop power control.

7. The method of any of embodiments 1-6, wherein the method comprises switching the type of power control such that the PUR transmission is sent according to open-loop power control and the subsequent PUR transmission is sent according to closed-loop power control.

8. The method of any of the previous embodiments, further comprising:
providing user data; and
forwarding the user data to a host computer via the transmission to the base station.

### Group B Embodiments

9. A method performed by a base station, the method comprising:
receiving a Preconfigured Uplink Resources (PUR) transmission from a wireless device;
sending a response to the PUR transmission to the wireless device;
determining a type of power control for receiving a subsequent PUR transmission, the determining based at least in part on the response to the PUR transmission; and
receiving the subsequent PUR transmission according to the selected type of power control.

10. The method of embodiment 10, wherein determining the type of power control comprises determining closed-loop power control based on sending an uplink grant message as the response to the PUR transmission.

11. The method of embodiment 10, wherein determining the type of power control comprises determining open-loop power control based on sending an acknowledge message as the response to the PUR transmission.

12. The method of embodiment 10, wherein determining the type of power control is further based on a PUR transmission periodicity.

13. The method of embodiment 14, wherein, when the response to the PUR transmission comprises an acknowledge message, determining the type of power control comprises determining open-loop power control based on a length of the PUR transmission periodicity exceeding a pre-determined length.

14. The method of embodiment 14, wherein, when the response to the PUR transmission comprises an acknowledge message, determining the type of power control comprises determining closed-loop power control based on a length of the PUR transmission periodicity being less than a pre-determined length.

15. The method of any of embodiments 10-16, wherein the method comprises switching the type of power control such that the PUR transmission is received according to closed-loop power control and the subsequent PUR transmission is received according to open-loop power control.

16. The method of any of embodiments 10-16, wherein the method comprises switching the type of power control such that the PUR transmission is received according to open-loop power control and the subsequent PUR transmission is received according to closed-loop power control.

17. The method of any of the previous embodiments, further comprising:
obtaining user data; and
forwarding the user data to a host computer or a wireless device.

### Group C Embodiments

18. A wireless device, the wireless device comprising:
processing circuitry configured to perform any of the steps of any of the Group A embodiments; and
power supply circuitry configured to supply power to the wireless device.

19. A base station, the base station comprising:
processing circuitry configured to perform any of the steps of any of the Group B embodiments;
power supply circuitry configured to supply power to the base station.

20. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

21. A computer program, the computer program comprising instructions which when executed on a computer perform any of the steps of any of the Group A embodiments.

22. A computer program product comprising a computer program, the computer program comprising instructions which when executed on a computer perform any of the steps of any of the Group A embodiments.

23. A non-transitory computer-readable storage medium or carrier comprising a computer program, the computer program comprising instructions which when executed on a computer perform any of the steps of any of the Group A embodiments.

24. A computer program, the computer program comprising instructions which when executed on a computer perform any of the steps of any of the Group B embodiments.

25. A computer program product comprising a computer program, the computer program comprising instructions which when executed on a computer perform any of the steps of any of the Group B embodiments.

26. A non-transitory computer-readable storage medium or carrier comprising a computer program, the computer program comprising instructions which when executed on a computer perform any of the steps of any of the Group B embodiments.

27. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

28. The communication system of the pervious embodiment further including the base station.

29. The communication system of the previous 2 embodiments, further including the UE, wherein the UE is configured to communicate with the base station.

30. The communication system of the previous 3 embodiments, wherein:
the processing circuitry of the host computer is configured to execute a host application, thereby providing the user data; and
the UE comprises processing circuitry configured to execute a client application associated with the host application.

31. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

32. The method of the previous embodiment, further comprising, at the base station, transmitting the user data.

33. The method of the previous 2 embodiments, wherein the user data is provided at the host computer by executing a host application, the method further comprising, at the UE, executing a client application associated with the host application.

34. A user equipment (UE) configured to communicate with a base station, the UE comprising a radio interface and processing circuitry configured to performs the of the previous 3 embodiments.

35. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

36. The communication system of the previous embodiment, wherein the cellular network further includes a base station configured to communicate with the UE.

37. The communication system of the previous 2 embodiments, wherein:
the processing circuitry of the host computer is configured to execute a host application, thereby providing the user data; and
the UE's processing circuitry is configured to execute a client application associated with the host application.

38. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

39. The method of the previous embodiment, further comprising at the UE, receiving the user data from the base station.

40. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

41. The communication system of the previous embodiment, further including the UE.

42. The communication system of the previous 2 embodiments, further including the base station, wherein the base station comprises a radio interface configured to communicate with the UE and a communication interface configured to forward to the host computer the user data carried by a transmission from the UE to the base station.

43. The communication system of the previous 3 embodiments, wherein:
the processing circuitry of the host computer is configured to execute a host application; and
the UE's processing circuitry is configured to execute a client application associated with the host application, thereby providing the user data.

44. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

45. A method implemented in a communication system including a host computer, a base station and a user equipment (UE), the method comprising:
at the host computer, receiving user data transmitted to the base station from the

UE, wherein the UE performs any of the steps of any of the Group A embodiments.

46. The method of the previous embodiment, further comprising, at the UE, providing the user data to the base station.

47. The method of the previous 2 embodiments, further comprising:
at the UE, executing a client application, thereby providing the user data to be transmitted; and
at the host computer, executing a host application associated with the client application.

48. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

49. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

50. The communication system of the previous embodiment further including the base station.

51. The communication system of the previous 2 embodiments, further including the UE, wherein the UE is configured to communicate with the base station.

52. The communication system of the previous 3 embodiments, wherein:
the processing circuitry of the host computer is configured to execute a host application;
the UE is configured to execute a client application associated with the host application, thereby providing the user data to be received by the host computer.

53. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

54. The method of the previous embodiment, further comprising at the base station, receiving the user data from the UE.

55. The method of the previous 2 embodiments, further comprising at the base station, initiating a transmission of the received user data to the host computer.

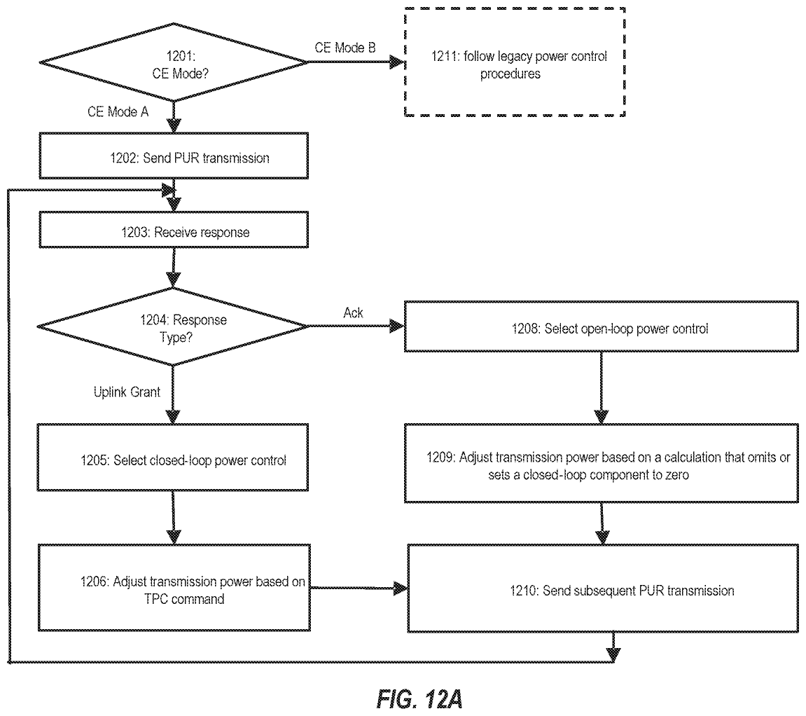

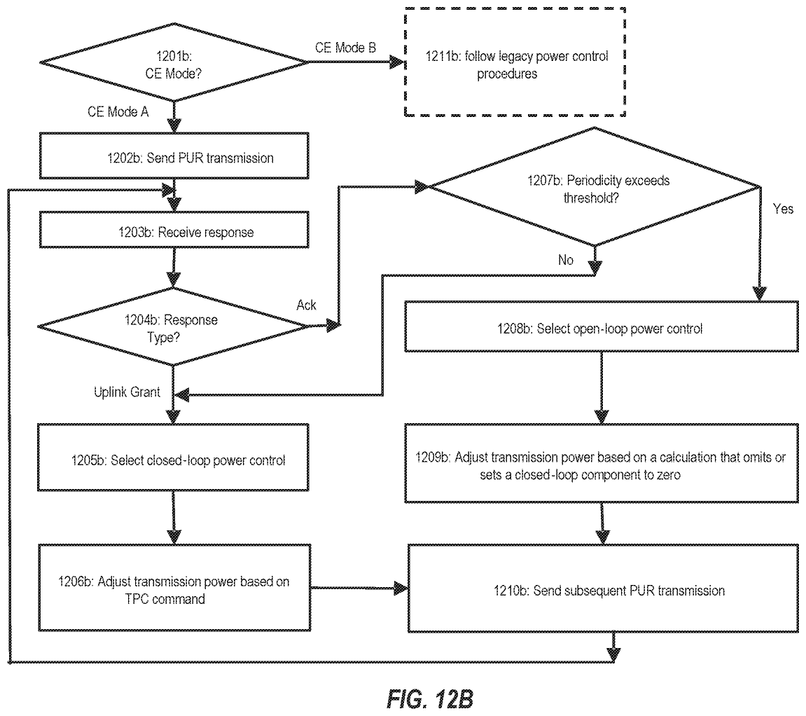

FIG. 12A depicts a method in accordance with particular embodiments. In certain embodiments, the method may be performed by a wireless device (e.g., wireless device 110), such as a UE (e.g., UE 200). For example, processing circuitry 120 (e.g., processing circuitry 201 of UE 200) may be configured to perform the steps of the method. The method begins at step 1201 with determining the CE Mode of the wireless device. In certain embodiments, the CE Mode may depend on radio coverage conditions (e.g., the enhancements of CE Mode A may be suitable for certain radio coverage conditions, and the enhancements of CE Mode B may be suitable for other radio coverage conditions). For CE Mode A, the method proceeds to step 1202. For CE Mode B, the method proceeds to step 1211.

At step 1202, the wireless device sends a PUR transmission (e.g., transmission A) to a network node, at step 1203, the wireless device receives a response to the PUR transmission from the network node, and at step 1204, the wireless device determines the type of response received in step 1203 so that the wireless device can select a type of power control for a subsequent PUR transmission (e.g., transmission B) based at least in part on the response to the PUR transmission received in step 1203.

Based on receiving an uplink grant message as the response to the PUR transmission in step 1203, the wireless device selects closed-loop power control (as shown in step 1205). In certain embodiments, receiving the uplink grant message in step 1203 indicates that the network node requires the wireless device to retransmit the PUR transmission that was sent in step 1202. The closed-loop power control used for the retransmission may involve adjusting a transmission power of the wireless device based at least in part on a TPC command received from the network node (as shown in step 1206). For example, the TPC command may indicate a correction value for use in power control. The method then proceeds to step 1210 with sending the subsequent PUR transmission (the retransmission) according to the closed-loop power control selected in step 1205.

Based on receiving an ACK as the response to the PUR transmission in step 1203, the wireless device selects open-loop power control (as shown in step 1208). In certain embodiments, receiving the ACK in step 1203 indicates that the network node does not require the wireless device to retransmit the PUR transmission that was sent in step 1202. The open-loop power control used for the subsequent PUR transmission may involve adjusting a transmission power of the wireless device based at least in part on a calculation where a closed-loop component has been omitted or set to zero (as shown in step 1209). For example, DCI received from the network node may set the TPC command to zero or may omit the TPC command (and optionally reallocate the DCI bits that would have otherwise been used for the TPC command for another purpose). The method then proceeds to step 1210 with sending the subsequent PUR transmission (the new transmission/transmission that is not a retransmission) according to the open-loop power control selected in step 1210.

In certain embodiments, the method may handle the subsequent PUR transmission sent in step 1210 similarly to the PUR transmission sent in step 1202. For example, the method may return to step 1203 where the wireless device receives a response to the subsequent PUR transmission (e.g., transmission B) from the network node and may then proceed to step 1204 where the wireless device determines the type of response received in step 1203 so that the wireless device can select a type of power control for a next subsequent PUR transmission (e.g., transmission C) based at least in part on the response to the PUR transmission received in step 1203.

By selecting the type of power control for a subsequent PUR transmission based at least in part on the response to the previous PUR transmission, the method may allow for switching from open-loop power control to closed-loop power control, or vice-versa. As an example, in the case where the PUR transmission sent in step 1202 is not a retransmission, the PUR transmission may be sent according to open-loop power control. If the subsequent PUR transmission to be sent in step 1210 corresponds to a retransmission, the method may switch to closed-loop power control. As another example, in the case where the PUR transmission sent in step 1202 is a retransmission, the PUR transmission may be sent according to closed-loop power control. If the subsequent PUR transmission to be sent in step 1210 corresponds to a new transmission (a transmission other than a retransmission), the method may switch to open-loop power control.

As discussed above, for CE Mode B, the method proceeds from step 1201 to step 1211. In step 1211, the wireless device performs legacy power control procedures for CE Mode B. For example, as described above, for a BL/CE UE configured with CEModeB, the PUSCH transmit power in subframe ik is determined by:

P_{PUSCH,c}(iₖ)=P_{CMAX,c}(i₀)

That is, when in CE Mode B, the wireless device may send one or more PUR retransmissions according to a maximum transmission power. Thus, for retransmissions in CE Mode A, the transmission power is adjusted using closed loop power control (e.g., using the TPC command in the uplink grant to adjust the transmission power), whereas for retransmissions in CE Mode B, the transmission power is adjusted according to legacy power control procedures (the wireless device uses maximum transmission power).

In certain embodiments, the wireless device may change CE modes sometime after step 1201, for example, based on changes in radio coverage conditions. As an example, suppose the wireless device changes from CE Mode A to CE Mode B. In response, certain embodiments of the wireless device may proceed from step 1210 to step 1201 in order to follow the CE Mode B procedures (step 1211) rather than returning to step 1203 after step 1210.

FIG. 12B depicts a method in accordance with particular embodiments. In certain embodiments, the method may be performed by a wireless device (e.g., wireless device 110), such as a UE (e.g., UE 200). For example, processing circuitry 120 (e.g., processing circuitry 201 of UE 200) may be configured to perform the steps of the method. The steps of FIG. 12B are generally analogous to the corresponding steps of FIG. 12A. FIG. 12B adds step 1207b such that when the response to the PUR transmission received in step 1203b comprises an acknowledgement message (as shown in the “ACK” branch of step 1204b), selecting the type of power control is further based on a PUR transmission periodicity. When a length of the PUR transmission periodicity at step 1207b exceeds a pre-determined length, the method proceeds to step 1208b with selecting open-loop power control. Alternatively, when the length of the PUR transmission periodicity at step 1207b is less than the pre-determined length, the method proceeds to step 1205b with selecting closed-loop power control. The pre-determined length of the PUR transmission periodicity may be based on when the power control parameters are likely to have become outdated (e.g., a closed-loop component of the power control parameters has less likelihood of having become outdated for a PUR transmission periodicity less than the pre-determined length, and greater likelihood of having become outdated for a PUR transmission periodicity that exceeds the pre-determined length).

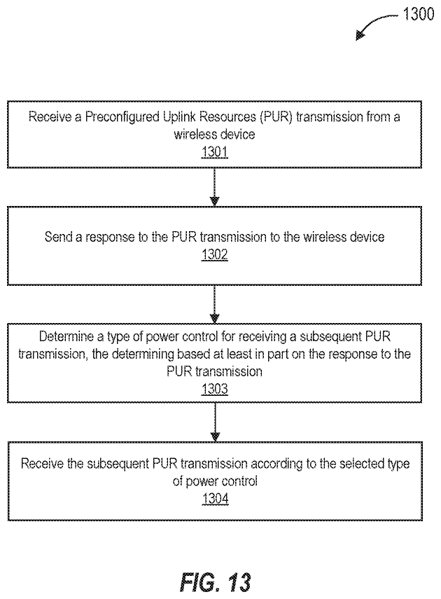

FIG. 13 depicts a method in accordance with particular embodiments. In certain embodiments, the method may be performed by a network node, such as network node 160. For example, processing circuitry 170 may be configured to perform the steps of the method. In general, steps performed by the network node may be reciprocal to steps described above as being performed by the wireless device (e.g., wireless device 110 or UE 200). As an example, in the case of messages described above as being sent from a wireless device to a network node, the network node may perform the step of receiving the message from the wireless device. As another example, in the case of messages described above as being received by a wireless device, the network node may perform the step of sending the message to the wireless device.

The method of FIG. 13 begins at step 1301 with receiving a PUR transmission from a wireless device. The method proceeds to step 1302 with sending a response to the PUR transmission to the wireless device. For example, if the network node was able to receive the PUR transmission of step 1301 successfully, the network node may send an ACK in step 1302. If the network node was not able to receive the PUR transmission of step 1301 successfully, the network node may send an uplink grant message in step 1302 in order to indicate that the network node requires the wireless device to send a retransmission of the PUR transmission.

At step 1303, the network node determines a type of power control for receiving a subsequent PUR transmission. The determining is based at least in part on the response to the PUR transmission sent in step 1302, for example:
If at step 1302 the network node sent an uplink grant message as the response to the PUR transmission, the network node may determine closed-loop power control at step 1303. In certain embodiments, the closed-loop power control comprises sending the wireless device a TPC command The TPC command may provide the wireless device with a closed-loop component (e.g., correction value) for power control.
If at step 1302 the network node sent an ACK as the response to the PUR transmission, the network node may determine open-loop power control at step 1303. In certain embodiments, the open-loop power control comprises sending the wireless device a TPC command set to zero or abstaining from sending the TPC command to the wireless device (optionally, the network node can reallocate the DCI bits that would have otherwise been used for the TPC command for another purpose).

In certain embodiments, determining the type of power control in step 1303 is further based on a PUR transmission periodicity. For example, if at step 1302 the network node sent an ACK as the response to the PUR transmission, the method determines open-loop power control at step 1303 when a length of the PUR transmission periodicity exceeds a pre-determined length, and the method determines closed-loop power control at step 1303 when the length of the PUR transmission periodicity is less than the pre-determined length.

The method proceeds to step 1304 with receiving the subsequent PUR transmission according to the type of power control determined in step 1303.

As discussed above, the methods disclosed herein may allow for switching from open-loop power control to closed-loop power control, or vice versa. In certain embodiments, the method of FIG. 13 further comprises switching the type of power control such that the PUR transmission that is not a retransmission is received according to open-loop power control and the subsequent PUR transmission in case it corresponds to a retransmission is received according to closed-loop power control. In certain embodiments, the method comprises switching the type of power control such that the PUR transmission that corresponds to a retransmission is received according to closed-loop power control and the subsequent PUR transmission that is not a retransmission is received according to open-loop power control.

In certain embodiments, the above-described steps of FIG. 13 may be performed when the wireless device is in CE Mode A. The network node may follow legacy power control when the wireless device is in CE Mode B. For example, the method may further comprise determining that the wireless device has entered CE Mode B and receiving one or more PUR retransmissions according to a maximum transmission power of the wireless device when the wireless device is in CE Mode B.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the following claims.

At least some of the following abbreviations may be used in this disclosure. If there is an inconsistency between abbreviations, preference should be given to how it is used above. If listed multiple times below, the first listing should be preferred over any subsequent listing(s).

3GPP 3rd Generation Partnership Project

5G 5th Generation

ABS Almost Blank Subframe

ACK Acknowledge

ARQ Automatic Repeat Request

BCCH Broadcast Control Channel

BCH Broadcast Channel

CA Carrier Aggregation

CB S-PUR Contention Based Shared-Preconfigured Uplink Resources

CC Carrier Component

CCCH SDU Common Control Channel SDU

CDMA Code Division Multiplexing Access

CE Coverage Enhanced/Enhancement

CFS-PUR Contention Free Shared-Preconfigured Uplink Resources

CGI Cell Global Identifier

CIR Channel Impulse Response

CP Cyclic Prefix

CPICH Common Pilot Channel

CPICH Ec/No CPICH Received energy per chip divided by the power density in the band

CQI Channel Quality information

C-RNTI Cell RNTI

CSI Channel State Information

DCCH Dedicated Control Channel

DCI Downlink Control Information

DL Downlink

DM Demodulation

DMRS Demodulation Reference Signal

DRX Discontinuous Reception

DTX Discontinuous Transmission

E-CID Enhanced Cell-ID (positioning method)

E-SMLC evolved Serving Mobile Location Center

E-UTRAN Evolved UTRAN

ECGI Evolved CGI

EDT Early Data Transmission

eMTC enhanced Machine-Type Communications

eNB E-UTRAN NodeB or evolved NodeB

ePDCCH enhanced Physical Downlink Control Channel

FDD Frequency Division Duplex

FFS For Further Study

GERAN GSM EDGE Radio Access Network

gNB Base station in NR

GNSS Global Navigation Satellite System

GSM Global System for Mobile communication

HARQ Hybrid Automatic Repeat Request

HL Higher Layer

HO Handover

HSPA High Speed Packet Access

HRPD High Rate Packet Data

IoT Internet of Things

LPP LTE Positioning Protocol

LTE Long-Term Evolution

MAC Medium Access Control

MPDCCH MTC Physical Downlink Control Channel

MDT Minimization of Drive Tests

MIB Master Information Block

MME Mobility Management Entity

MSC Mobile Switching Center

MTC Machine-Type Communications

NR New Radio

OCNG OFDMA Channel Noise Generator

OFDM Orthogonal Frequency Division Multiplexing

OFDMA Orthogonal Frequency Division Multiple Access

OSS Operations Support System

O&M Operation and Maintenance

PBCH Physical Broadcast Channel

P-CCPCH Primary Common Control Physical Channel

PCell Primary Cell

PCFICH Physical Control Format Indicator Channel

PDCCH Physical Downlink Control Channel

PDP Profile Delay Profile

PDSCH Physical Downlink Shared Channel

PGW Packet Gateway

PHICH Physical Hybrid-ARQ Indicator Channel

PLMN Public Land Mobile Network

PMI Precoder Matrix Indicator

PRACH Physical Random Access Channel

PRB Physical Resource Block

PRS Positioning Reference Signal

PSS Primary Synchronization Signal

PUCCH Physical Uplink Control Channel

PUR Preconfigured Uplink Resources

PUSCH Physical Uplink Shared Channel

RACH Random Access Channel

QAM Quadrature Amplitude Modulation

RAN Radio Access Network

RAT Radio Access Technology

RLM Radio Link Management

RNC Radio Network Controller

RNTI Radio Network Temporary Identifier

RRC Radio Resource Control

RRM Radio Resource Management

RS Reference Signal

RSTD Reference Signal Time Difference

RU Resource Unit

SCH Synchronization Channel

SCell Secondary Cell

SDU Service Data Unit

SFN System Frame Number

SGW Serving Gateway

SI System Information

SIB System Information Block

SNR Signal to Noise Ratio

SON Self Optimized Network

SS Synchronization Signal

SSS Secondary Synchronization Signal

TA Timing Advance

TBS Transport Block Size

TDD Time Division Duplex

TOA Time of Arrival

TSS Tertiary Synchronization Signal

TTI Transmission Time Interval

UE User Equipment

UL Uplink

USIM Universal Subscriber Identity Module

UTRA Universal Terrestrial Radio Access

UTRAN Universal Terrestrial Radio Access Network

WI Work Item

WLAN Wide Local Area Network

1. A method performed by a wireless device, the method comprising:
sending a Preconfigured Uplink Resources (PUR) transmission to a network node;
receiving a response to the PUR transmission from the network node;
selecting a type of power control for a subsequent PUR transmission, the selecting based at least in part on the response to the PUR transmission; and
sending the subsequent PUR transmission according to the selected type of power control.

2. The method of claim 1, wherein selecting the type of power control comprises selecting closed-loop power control based at least in part on receiving an uplink grant message as the response to the PUR transmission.

3. The method of claim 2, wherein the subsequent PUR transmission comprises a retransmission of the PUR transmission, and wherein the closed-loop power control comprises adjusting a transmission power of the wireless device based at least in part on a transmit power control (TPC) command received from the network node.

4. The method of claim 1, wherein selecting the type of power control comprises selecting open-loop power control based at least in part on receiving an acknowledge message as the response to the PUR transmission.

5. The method of claim 4, wherein the subsequent PUR transmission comprises a transmission that is not a retransmission, and wherein the open-loop power control comprises adjusting a transmission power of the wireless device based at least in part on a calculation where a closed-loop component has been omitted or set to zero.

6. The method of claim 1, wherein the method comprises switching the type of power control such that the PUR transmission that is not a retransmission is sent according to open-loop power control and the subsequent PUR transmission in case it corresponds to a retransmission is sent according to closed-loop power control.

7. The method of claim 1, wherein the method comprises switching the type of power control such that the PUR transmission that corresponds to a retransmission is sent according to closed-loop power control and the subsequent PUR transmission that is not a retransmission is sent according to open-loop power control.

8. The method of claim 1, wherein the wireless device is in Coverage Enhancement (CE) Mode A.

9. The method of claim 8, further comprising:
determining that the wireless device has entered CE Mode B; and
sending one or more PUR retransmissions according to a maximum transmission power when in CE Mode B.

10. The method of claim 1, wherein selecting the type of power control is further based on a PUR transmission periodicity such that when the response to the PUR transmission comprises an acknowledge message, selecting the type of power control comprises:
selecting open-loop power control when a length of the PUR transmission periodicity exceeds a pre-determined length; and
selecting closed-loop power control when the length of the PUR transmission periodicity is less than the pre-determined length.

11. A method performed by a network node, the method comprising:
receiving a Preconfigured Uplink Resources (PUR) transmission from a wireless device;
sending a response to the PUR transmission to the wireless device;
determining a type of power control for receiving a subsequent PUR transmission, the determining based at least in part on the response to the PUR transmission; and
receiving the subsequent PUR transmission according to the determined type of power control.

12. The method of claim 11, wherein determining the type of power control comprises determining closed-loop power control based at least in part on sending an uplink grant message as the response to the PUR transmission.

13. The method of claim 12, wherein the subsequent PUR transmission comprises a retransmission of the PUR transmission, and wherein the closed-loop power control comprises sending the wireless device a transmit power control (TPC) command.

14. The method of claim 11, wherein determining the type of power control comprises determining open-loop power control based at least in part on sending an acknowledge message as the response to the PUR transmission.

15. The method of claim 14, wherein the subsequent PUR transmission comprises a transmission that is not a retransmission, and wherein the open-loop power control comprises sending the wireless device a transmit power control (TPC) command set to zero or abstaining from sending the TPC command to the wireless device.

16. The method of claim 11, wherein the method comprises switching the type of power control such that the PUR transmission that is not a retransmission is received according to open-loop power control and the subsequent PUR transmission in case it corresponds to a retransmission is received according to closed-loop power control.

17. The method of claim 11, wherein the method comprises switching the type of power control such that the PUR transmission that corresponds to a retransmission is received according to closed-loop power control and the subsequent PUR transmission that is not a retransmission is received according to open-loop power control.

18. The method of claim 11, wherein the wireless device is in Coverage Enhancement (CE) Mode A.

19. The method of claim 18, further comprising:
determining that the wireless device has entered CE Mode B; and
receiving one or more PUR retransmissions according to a maximum transmission power of the wireless device when the wireless device is in CE Mode B.

20. The method of claim 11, wherein determining the type of power control is further based on a PUR transmission periodicity such that when the response to the PUR transmission comprises an acknowledge message, determining the type of power control comprises:
determining open-loop power control when a length of the PUR transmission periodicity exceeds a pre-determined length; and
determining closed-loop power control when the length of the PUR transmission periodicity is less than the pre-determined length.

21. A wireless device, the wireless device comprising:
transceiver circuitry to transmit and receive wireless signals; and
processing circuitry, in communication with the transceiver circuitry, the processing circuitry configured to:
send a Preconfigured Uplink Resources (PUR) transmission to a network node;
receive a response to the PUR transmission from the network node;
select a type of power control for a subsequent PUR transmission, the selecting based at least in part on the response to the PUR transmission; and
send the subsequent PUR transmission according to the selected type of power control.

22-44. (canceled)
